(19) United States
(12) Patent Application Publication
(10) Pub. No.: US 2003/0031844 A1
(43) Pub. Date: Feb. 13, 2003

(54) Multi-layer structures containing antistatic compounds

(76) Inventors: Rudiger Gorny, Krefeld (DE); Siegfried Anders, Koln (DE); Wolfgang Nising, Augustin (DE); Martin Dobler, Dusseldorf (DE); Jurgen Rohner, Koln (DE)

Correspondence Address: BAYER CORPORATION, PATENT DEPARTMENT, 100 BAYER ROAD, PITTSBURGH, PA, 15205, US

(21) Appl. No.: 10/123,384

(22) Filed: Apr. 16, 2002

(30) Foreign Application Priority Data
Apr. 20, 2001 (DE) 10119416.1

(51) Int. Cl. B32B 7/02

(52) U.S. Cl. 428/212; 428/323

(57) ABSTRACT

A multi-layer structure comprising at least two thermoplastic layers in which at least one layer comprises one or more antistatic compounds is described. The antistatic compounds are selected from perfluoroalkyl sulfonic acid salts, e.g., perfluoroalkyl sulfonic ammonium acid salts, perfluoroalkyl sulfonic phosphonium acid salts and perfluoroalkyl sulfonic sulfonium acid salts. The multi-layer structure may be selected from films, solid sheets and multi-walled sheets.

### CROSS REFERENCE TO RELATED PATENT APPLICATION

The present patent application claims the right of priority under 35 U.S.C. §119 (a)-(d) of German Patent Application No. 101 19 416.1, filed Apr. 20, 2001.

### FIELD OF THE INVENTION

The invention relates to multi-layer structures (e.g., solid sheets prepared by coextrusion), which have a relatively low tendency to accumulate dust and do not acquire static electricity during manufacture and use. At least one layer of the multi-layer structure of the present invention includes an internal antistatic compound or compounds. The multi-layer structures of the present invention are preferably transparent.

### BACKGROUND OF THE INVENTION

Thermoplastic extruded molded parts such as, e.g., polycarbonate sheets, are known, for example, from EP A 0 110 221 and are provided for a multiplicity of applications. Manufacture takes place by extrusion and optionally coextrusion of the thermoplastics.

In the case of plastic molded parts in general and polycarbonate sheets in particular, the accumulation of dust with the formation of dust deposits is a widespread problem. See in this connection, e.g., Saechtling, Kunststoff-Taschenbuch, 26th edition, Hanser Verlag, 1995, Munich, p. 140 f. They originate from electrostatic charging of the molded parts during manufacture. Dust deposits are particularly troublesome in the case of transparent, translucent thermoplastic molded parts and those pigmented in light or luminous colors. Moreover, the transparency may be reduced by dust accumulation and the function thereby impaired. Finally, electrostatic charges may by nature represent a risk, particularly during the handling of combustible materials or flammable dusts.

A known method of reducing electrostatic charging and hence dust accumulation on plastic parts is the use of antistatics. Antistatics which restrict dust accumulation are described for thermoplastics in the literature (see, e.g., Gäichter, Müiller, Plastic Additives, Hanser Verlag, Munich, 1996, p.749 ff). These antistatics improve the electrical conductivity of the plastic molding compositions and thus remove surface charges which form during manufacture and use. Dust particles are thus attracted to a lesser extent and consequently there is less dust accumulation.

As regards antistatics, a distinction is generally made between internal and external antistatics. An external antistatic is applied to the plastic molded part after processing, and an internal antistatic is added to the plastic molding compositions as an additive. For economic reasons, the use of internal antistatics is usually desirable because no further operating steps are required to apply the antistatic after processing. Few internal antistatics which also form completely transparent molded parts, particularly with polycarbonate, have been described hitherto in the literature. JP-A 06 228 420 describes aliphatic sulfonic acid ammonium salts in polycarbonate as an antistatic. These compounds lead, however, to a reduction in molecular weight in the polycarbonate melt and/or cloudiness due to incompatibility. JP-A 62 230 835 describes the addition of 4% nonylphenylsulfonic acid tetrabutylphosphonium in polycarbonate. WO-A 01/12713 describes the use of tetraethylammonium perfluorooctane sulfonate as an antistatic in polycarbonate. A disadvantage of this compound is the occurrence of yellowing after extrusion.

A disadvantage of the known antistatics is that these must be used in relatively high concentrations in order to achieve the antistatic effect. As a result, however, the material properties of the thermoplastics are altered in an undesirable manner.

Extruded molded parts of thermoplastics such as, for example, polycarbonate sheets are used mainly as pigmented sheets of a transparent, translucent or opaque nature. For cost reasons, the manufacture of such pigmented sheets is carried out by adding color masterbatches to unpigmented or slightly blue-tinted polycarbonate during extrusion.

As described previously herein, many antistatics when incorporated into thermoplastic polycarbonates result in yellowing and/or a reduction in molecular weight of the thermoplastic polycarbonate polymer.

If a masterbatch with a yellow color due to the antistatic is added during sheet extrusion, the impression of color of the sheets alters. In order to compensate for this impression of color, an adjustment must be made with colored pigments. Moreover, in the case of pigmented sheets, the color is weakened by the addition of an antistatic masterbatch.

Due to the reduction in molecular weight of the polycarbonate caused by the antistatic, the maximum antistatic concentration which can be used in the polycarbonate matrix is limited. Particularly in the case of pigmented sheets, the color is then weakened by the addition of the antistatic masterbatch.

Many antistatics also lead to an increase in haze when incorporated into thermoplastic polycarbonates.

### SUMMARY OF THE INVENTION

The object of the invention is, therefore, to provide molded parts and extrudates of antistatic thermoplastic molding compositions, of which the optical quality but also the other properties such as, e.g., the mechanical properties and heat distortion temperature do not differ substantially from those of non-antistatic molding compositions and parts.

Surprisingly, the object is achieved by preparation of a multi-layer structure of thermoplastic molding compositions which contain at least one particular antistatic compound, as represented by and described in further detail herein with reference to formula (I). This multi-layer structure is characterized in that it contains at least two thermoplastic layers, and at least one of these layers contains at least one antistatic compound represent by formula (I), as described in further detail herein.

Within the meaning of the invention, the multi-layer structure comprises at least two thermoplastic layers of the same or different thermoplastic polymers, and at least one thermoplastic layer contains one or more antistatic compounds represented by formula (I) herein.

Other than in the operating examples, or where otherwise indicated, all numbers expressing quantities of ingredients, reaction conditions, etc. used in the specification and claims are to be understood as modified in all instance by the term “about.”

### DETAILED DESCRIPTION OF THE INVENTION

The thickness of the entire multi-layer structure is preferably 21 μm to 10 cm, particularly preferably 40 μm to 15 mm and more particularly preferably 100 μm to 12 mm.

The thickness of the individual thermoplastic layers of the multi-layer structure is preferably 1 μm to 10 cm. The thickness of the layer or layers which contains the antistatic is advantageously from 1 μm to 200 μm, preferably 20 μm to 100 μm, particularly preferably 40 μm to 60 μm. The thickness of the layer or layers which do not contain the antistatic according to the invention is from 20 μm to 10 cm. In the case of films, the preferred thickness is from 20 μm to 600 μm, in the case of solid sheets from 600 μm to 15 mm, and in the case of multi-wall sheets from 0.4 cm to 10 cm.

The following two layer structures are particularly preferred (arrangement in the sequence described):

1. Two layered structure:

A layer containing the antistatic thermoplastic molding compound according to the invention

A layer containing thermoplastic molding compositions without the antistatic according to the invention.

2. Three layered structure:

A layer containing the antistatic thermoplastic molding compound according to the invention

a layer containing thermoplastic molding compositions without the antistatic according to the invention.

A layer containing the antistatic thermoplastic molding compound according to the invention.

The multi-layer structure of the present invention may be further characterized in that two of the thermoplastic layers define exterior layers of the structure. More particularly, at least one of the exterior layers of the multi-layer structure of the present invention comprises one or more antistatic compounds represented by formula (I). In an embodiment of the present invention the multi-layer structure comprises three thermoplastic layers, in which two of the thermoplastic layers define exterior layers of the multi-layer structure, and at least one of these exterior layers comprises at least one antistatic compound represented by formula (I)

The individual thermoplastic layers may, moreover, each independently, contain further additives, such as UV absorbers, heat stabilisers, antioxidants, mold release agents, flame retardants, dyes, pigments, brighteners, glass fibres, foaming agents, nucleating agents, plasticisers, processing aids, fillers or other additives conventionally used with thermoplastic polymers, in amounts from 0.001 wt. % to 30 wt. %. The more specifically suitable types of additives and the amount thereof are known to the skilled person (as described, e.g., in Gächter; Muller, Plastics Additives, Hanser Verlag, Munich 1996 or in EP 0 839 623 μl or EP 0 500 496 A1).

Suitable antistatics within the meaning of the present invention include perfluoroalkyl sulfonic acid salts represented by the following formula (I),

R—A—SO₃X (I)

wherein

R is a perfluorinated linear or branched carbon chain having 1 to 30 carbon atoms, preferably 4 to 8 carbon atoms;

A is (i) a direct bond or (ii) a divalent aromatic nucleus (i.e., a divalent aromatic linking group), for example and preferably fluorinated or non-fluorinated o-, m- or p-phenylene;

X is selected from the group consisting of an ammonium ion represented by NR⁵R⁶R⁷R⁸, a phosphonium ion represented by PR⁵R⁶R⁷R⁸, a sulfonium ion represented by SR⁵R⁶R⁷, substituted imidazolinium ion, unsubstituted imidazolinium ion, substituted pyridinium ion, unsubstituted pyridinium ion, substituted tropylium ion, and unsubstituted tropylium ion,

wherein,

R⁵, R⁶, R⁷and R⁸ each independently of one another and independently for each ion, are selected from, aromatic groups (e.g., phenyl or benzyl); cycloaliphatic groups (e.g., containing from 5 to 7 carbons in the cyclic ring, such as cyclohexyl, cyclohexylmethyl and cyclopentyl); and linear or branched C₁-C₃₀ carbon chains (preferably having 1 to 10 carbon atoms, e.g., methyl, ethyl, propyl, 1-butyl, 1-pentyl, hexyl, isopropyl, isobutyl, tert.-butyl, neopentyl, 2-pentyl, iso-pentyl, iso-hexyl); which may each be optionally substituted with at least one member selected from the group consisting of halogen (e.g., Cl and Br), hydroxy, cycloalkyl (e.g., C₅-C₇ cycloalkyls, such as cyclohexyl, cyclohexylmethyl and cyclopentyl) and C₁-C₃₀ alkyl (e.g., C₁-C₃ alkyl).

Substituent X is preferably selected from quatemary ammonium salts represented by NR⁵R⁶R⁷R⁸.

In an embodiment of the present invention, the antistatic compound represented by formula (I) is selected from perfluoroalkyl sulfonic ammonium acid salts. Examples of preferred perfluoroalkyl sulfonic ammonium acid salts from which the antistatic compound may be selected include, but are not limited to:

Perfluorooctane sulfonic acid tetraethylammonium salt

Perfluorobutane sulfonic acid tetraethylammonium salt

Perfluorooctane sulfonic acid tetrapropylammonium salt

Perfluorobutane sulfonic acid tetrapropylammonium salt

PerFluorooctane sulfonic acid tetrabutylammonium salt

Perfluorobutane sulfonic acid tetrabutylammonium salt

Perfluorooctane sulfonic acid tetrapentylammonium salt

Perfluorobutane sulfonic acid tetrapentylammonium salt

Perfluorooctane sulfonic acid tetrahexylammonium salt

Perfluorobutane sulfonic acid tetrahexylammonium salt

N-methyl-tripropylammonium perfluorobutyl sulfonate

N-methyl-tripropylammonium perfluorooctane sulfonate

N-ethyl-tripropylammonium perfluorobutyl sulfonate

N-ethyl-tripropylammonium perfluorooctane sulfonate

Dimethyldiisopropylammonium perfluorobutyl sulfonate

Dimethyldiisopropylammonium perfluorooctane sulfonate

Dimethyldiisopropylmethylammonium perfluorobutyl sulfonate

Dimethyldiisopropylmethylammonium perfluorooctane sulfonate

N-methyl-tributylammonium perfluorobutyl sulfonate

N-methyl-tributylammonium perfluorooctane sulfonate

Cyclohexyl diethylmethylammonium perfluorobutyl sulfonate

Cyclohexyl diethylmethylammonium perfluorooctane sulfonate

Cyclohexyltrimethylammonium perfluorobutyl sulfonate

Cyclohexyltriemethyl ammonium perfluorooctane sulfonate

and the corresponding trifluoromethane sulfonates.

The above recited sulfonic acid salts may each be used alone or as mixtures in the present invention.

The perfluoroalkyl sulfonic acid ammonium salts are known and may be prepared by art-recognized methods. The salts of the sulfonic acids can be prepared by adding equimolar amounts of the free sulfonic acid with the hydroxy form of the corresponding cation in water at room temperature and concentrating the solution. Other methods of preparation are described, e.g., in DE A 19 66 931 and NL A 7 802 830 or in Pomaville et al., J. Chromatogr. (1989), Volume Date 1988, 468, page 261-278.

The perfluoroalkyl sulfonic acid ammonium salts are added to the plastics preferably in amounts of 0.001 wt. % to 2 wt. %, more preferably 0.1 wt. % to 1 wt. %.

Suitable thermoplastics within the meaning of the invention include, in particular, transparent thermoplastics. Polymers of ethylenically unsaturated monomers and/or polycondensates of bifunctional reactive compounds are preferred.

Particularly suitable thermoplastics include polycarbonates or copolycarbonates based on bisphenols, poly- or copolyacrylates, and poly- or copolymethacrylates such as, for example and preferably polymethylmethacrylate. Further thermoplastic polymers include: polymers or copolymers with styrene, such as and preferably transparent polystyrene or polystyrene acrylonitrile (SAN); transparent thermoplastic polyurethanes; polyolefins, such as and preferably transparent polypropylene polymers or polyolefins based on cyclic olefins (e.g., TOPAS®, Hoechst); poly- or copolycondensates of terephthalic acid with or without isophthalic acid, with ethylene glycol and/or cyclohexane dimethanol such as, for example and preferably poly- or copolyethylene terephthalate (PET or CoPET) or cyclohexane dimethanol-modified PET (PETG). Polycarbonates or copolycarbonates are particularly preferred, particularly non-halogenated polycarbonates and/or copolycarbonates with weight-average molecular weights \vec{M}_{W} of 5000 to 100,000, preferably 10,000 to 50,000, and particularly preferably 15,000 to 40,000.

Homopolycarbonates, copolycarbonates and thermoplastic polyester carbonates are particularly suitable. They have weight-average molecular weights M w of 18,000 to 40,000, preferably 26,000 to 36,000 and particularly 28,000 to 35,000, determined by measuring the rel. solution viscosity in dichloromethane or in mixtures of the same weight amounts of phenol/o-dichlorobenzene calibrated by light scattering.

The melt viscosity of the molding compositions containing the antistatic should preferably be less than the melt viscosity of the molding compound of the other layers.

With regard to the preparation of polycarbonates for the molding compositions according to the invention, reference is made by way of example to “Schnell”, Chemistry and Physics of Polycarbonates, Polymer Reviews, Vol. 9, Interscience Publishers, New York, London, Sydney 1964, to D. C. PREVORSEK, B. T. DEBONA and Y. KESTEN, Corporate Research Center, Allied Chemical Corporation, Moristown, N.J. 07960, “Synthesis of Poly(ester) carbonate Copolymers”, in Journal of Polymer Science, Polymer Chemistry Edition, Vol. 19, 75-90 (1980), to D. Freitag, U. Grigo, P. R. Müller, N. Nouvertne, BAYER AG, “Polycarbonates” in Encyclopedia of Polymer Science and Engineering, Vol. 11, Second Edition, 1988, pages 648-718 and finally to Dres. U. Grigo, K. Kircher and P. R. Muller “Polycarbonate” in Becker/Braun, Kunststoff-Handbuch, Vol. 3/1, Polycarbonates, Polyacetals, Polyesters, Cellulose esters, Carl HanserVerlag, Munich, Vienna 1992, pages 117-299. Preparation takes place preferably by the interfacial method or the melt-transesterification method and is described by way of example on the basis of the interfacial method.

Compounds preferred as starting compounds include bisphenols corresponding to the general formula HO—Z—OH wherein Z is a divalent organic radical having 6 to 30 carbon atoms and containing one or more aromatic groups, Examples of such compounds include bisphenols which belong to the group comprising dihydroxydiphenyls, bis(hydroxyphenyl) alkanes, indane bisphenols, bis(hydroxyphenyl) ethers, bis(hydroxyphenyl) sulfones, bis(hydroxyphenyl) ketones and α, α′-bis(hydroxyphenyl) diisopropylbenzenes.

Particularly preferred bisphenols which belong to the above-mentioned groups of compounds include bisphenol-A (2,2-bis-(4-hydroxyphenyl) propane), tetraalkyl bisphenol-A, 4,4-(meta-phenylene diisopropyl) diphenol (bisphenol M), 4,4-(para-phenylene diisopropyl) diphenol, 1,1-bis-(4-hydroxyphenyl)-3,3,5-trimethylcyclohexane (BP-TMC) and optionally mixtures thereof. Homopolycarbonates based on bisphenol-A and copolycarbonates based on the monomers bisphenol-A and 1,1-bis-(4-hydroxyphenyl)-3,3,5-trimethylcyclohexane are particularly preferred. The bisphenol compounds to be used according to the invention are reacted with carbonic acid compounds, particularly phosgene or, in the melt transesterification process, diphenyl carbonate or dimethyl carbonate.

Polyester carbonates are obtained by reaction of the bisphenols already mentioned, at least one aromatic dicarboxylic acid and optionally carbonic acid equivalents. Suitable aromatic dicarboxylic acids include, for example, phthalic acid, terephthalic acid, isophthalic acid, 3,3′- or 4,4′-diphenyldicarboxylic acid and benzophenone dicarboxylic acids. A part, up to 80 mole %, preferably from 20 mole % to 50 mole %, of the carbonate groups in the polycarbonates may be replaced by aromatic dicarboxylic acid ester groups.

Inert organic solvents used in the interfacial method include, for example, dichloromethane, the various dichloroethanes and chloropropane compounds, tetrachloromethane, trichloromethane, chlorobenzene and chlorotoluene; the use of chlorobenzene or dichloromethane or mixtures of dichloromethane and chlorobenzene is preferred.

The interfacial reaction may be accelerated by catalysts such as tertiary amines, particularly N-alkylpiperidines or onium salts. The use of tributylamine, triethylamine and N-ethylpiperidine is preferred. In the case of the melt transesterification process, the catalysts mentioned in DE A 42 38 123 are used.

The polycarbonates may be branched in a known and controlled manner by the use of small amounts of branching agents. Some suitable branching agents include: phloroglucinol, 4,6-dimethyl-2,4,6-tri-(4-hydroxyphenyl)-heptene-2; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-bis-(4-hydroxyphenyl)-cyclohexyl]-propane; 2,4-bis-(4-hydroxyphenylisopropyl)-phenol; 2,6-bis-(2-hydroxy-5′-methylbenzyl)4-methylphenol; 2-(4-hydroxyphenyl)-2-(2,4-dihydroxyphenyl)-propane; hexa-(4-(4-hydroxyphenyl-isopropyl)-phenyl)-orthoterephthalic acid ester; tetra-(4-hydroxyphenyl)-methane; tetra-(4-(4-hydroxyphenyl-isopropyl)-phenoxy)-methane; ααα′, ααα″-tris(4-hydroxyphenyl)-1,3,5-triisopropylbenzene; 2,4-dihydroxybenzoic acid; trimesic acid; cyanuric chloride; 3,3-bis-(3-methyl-4-hydroxyphenyl)-2-oxo-2,3-dihydroindole; 1,4-bis-(4′,4″-dihydroxytriphenyl)-methyl)-benzene and in particular: 1,1,1-tri-(4-hydroxyphenyl)-ethane and 3,3-bis-(3-methyl-4-hydroxyphenyl)-2-oxo-2,3-dihydroindole.

The 0.05 mole % to 2 mole %, based on diphenols used, of branching agents or mixtures of branching agents optionally to be incorporated may be used together with the diphenols but may also be added in a later stage of the synthesis.

Chain terminating agents used are preferably phenols such as phenol, alkyl phenols such as cresol and 4-tert-butylphenol, chlorophenol, bromophenol, cumylphenol or mixtures thereof, used in amounts of 1-20 mole%, preferably 2-10 mole% per mole of bisphenol. Phenol, 4-tert-butylphenol and cumylphenol are preferred.

Chain terminating agents and branching agents may be added to the syntheses separately or together with the bisphenol.

The preparation of the polycarbonates for the molding compositions according to the invention by the melt transesterification process is described by way of example in DE A 42 38 123.

Additives suitable as UV absorbers within the meaning of the invention are described, for example in EP A 0 839 623 (page 23f) and EP A 0 500 496 (page 2, compound 1, and page 6f, chapter 2).

Derivatives of benzotriazole, of benzophenone, of triazine, and arylated cyanoacrylates and further conventional UV absorbers are particularly suitable.

UV absorbers particularly suitable according to the invention for the molding compositions to be used include compounds which, in view of their absorption capacity below 400 nm, are capable of protecting polycarbonate effectively from UV light.

Suitable UV absorbers include, in particular, the compounds described in WO 99/05205 corresponding to the following formula (II),

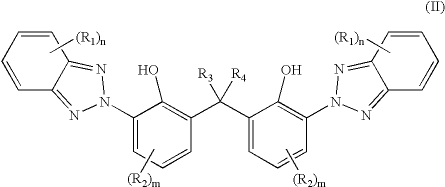

wherein R₁ and R₂ are the same or different and represent H, halogen, C₁-C₁₀-alkyl, C₅-C₁₀-cycloalkyl, C₇-C₁₃-aralkyl, C₆-C₁₄-aryl, —OR⁵ or —(CO)—O—R⁵ with R⁵═H or C₁-C₄-alkyl;

R₃ and R₄ are likewise the same or different and represent H, C₁-C₄-alkyl, C₅-C₆-cycloalkyl, benzyl or C₆-C₁₄-aryl; and

m is 1, 2, or 3 and n is 1, 2, 3 or 4.

A further suitable UV absorber is represented by the following formula (III),

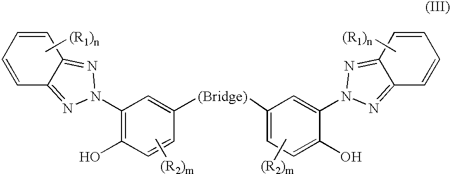

wherein the bridge (i.e., bridge) is represented by the following formula,

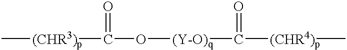

and for which R¹, R², m and n each are as described previously herein with reference to formula (11);

p is an integer from 0 to 3;

q is an integer from 1 to 10;

Y is —CH₂—CH₂—, —(CH₂)₃—, —(CH₂)₄—, —(CH₂)₅—, —(CH₂)₆—, or CH(CH₃)—CH₂—; and

R³ and R⁴ each are as described previously herein with reference to formula (II).

Further suitable UV absorbers according to the invention include those which represent substituted triazines such as 2,4-bis(2,4-dimethylphenyl)-6-(2-hydroxy-4-n-octyloxyphenyl)-1,3,5-triazine (CYASORB® UV-1164) or 2-(4,6-diphenyl-1,3,5-triazin-2-yl)-5-(hexyl)oxy phenol (Tinuvin® 1577). A particularly preferred UV absorber is 2,2-methylene bis-(4-(1,1,3,3-tetramethylbutyl)-6-(2H-benzotriazol-2-yl)phenol) which is sold commercially under the name Tinuvin® 360 or Adeka Stab® LA 31. The UV absorbers mentioned in EP 0500496 μl are also suitable. The UV absorber Uvinul 3030 from BASF AG obtained in WO 96115102, Example 1, may also be used.

Further suitable UV absorbers according to the invention include hydroxy benzotriazoles such as 2-(3′,5′-bis-(1,1-dimethylbenzyl)-2′-hydroxyphenyl)-benzotriazole (Tinuvin® 234, Ciba Spezialitatenchemie, Basel), 2-(2′-hydroxy-5′-(tert-octyl)-phenyl)-benzotriazole (Tinuvin® 329, Ciba Spezialitatenchemie), 2-(2′-hydroxy-3′-(2-butyl)-5′-(tert-butyl)-phenyl)-benzotriazole (Tinuvin® 350, Ciba Spezialitätenchemie), bis-(3-(2H-benzotriazolyl)-2-hydroxy-5-tert-octyl) methane, (Tinuvin® 360, Ciba Spezialitätenchemie), 2-(4-hexoxy-2-hydroxyphenyl)-4,6-diphenyl-1,3,5-triazine (Tinuvin® 1577, Ciba Spezialitatenchemie), and 2,4-dihydroxy-benzophenone (Chimasorb22®, Ciba Spezialitätenchemie) and 2-hydroxy-4-(octyloxy)-benzophenone (Chimasorb81®, Ciba Spezialitätenchemie).

The UV absorbers are used preferably in amounts of, in each case, from 0.001 wt. % to 20 wt. %, preferably 0.01 wt. % to 1 wt. %, advantageously from 0.1 wt. % to 1 wt. % and more particularly preferably from 0.2 wt. % to 0.6 wt. %. For exterior applications, amounts of advantageously 2 wt. % to 11 wt. %, preferably 3 wt. % to 10 wt. % and more particularly preferably from 3 wt. % to 7 wt. % are used.

Suitable stabilizers for the polycarbonates for the molding compositions according to the invention include, for example, phosphines, phosphites or Si-containing stabilisers and further compounds described in EP-A 0 839 623 (page 21, chapter 1). Examples include triphenyl phosphites, diphenylalkyl phosphites, phenyidialkyl phosphites, tris-(nonylphenyl) phosphite, tetrakis-(2,4-di-tert.-butylphenyl)-4,4′-biphenylene diphosphonite and triaryl phosphite. Triphenylphosphine and tris-(2,4-di-tert.-butylphenyl) phosphite are particularly preferred.

Moreover, the molding compound according to the invention may contain 0.01 wt. % to 0.5 wt. % of the (partial) esters of mono- to hexahydric alcohols, particularly of glycerol, pentaerythritol or Guerbet alcohols.

Examples of monohydric alcohols include stearyl alcohol, palmityl alcohol and Guerbet alcohols. An example of a dihydric alcohol is glycol. An example of a trihydric alcohol is glycerol. Examples of tetrahydric alcohols include pentaerythritol and mesoerythritol. Examples of pentahydric alcohols include arabitol, ribitol and xylitol. Examples of hexahydric alcohols include mannitol, glucitol (sorbitol) and dulcitol.

The esters are the monoesters, diesters, triesters, tetraesters, optionally pentaesters and hexaesters or mixtures thereof, particularly random mixtures, of saturated, aliphatic C₁₀ to C₃₆ monocarboxylic acids and optionally hydroxy monocarboxylic acids, preferably with saturated aliphatic C₁₄ to C₃₂ monocarboxylic acids and optionally hydroxy monocarboxylic acids.

The commercially available fatty acid esters, particularly of pentaerythritol and of glycerol may, for production reasons, contain <60% of different partial esters.

Examples of saturated aliphatic monocarboxylic acids with 10 to 36 carbon atoms include capric acid, lauric acid, myristic acid, palmitic acid, stearic acid, hydroxystearic acid, arachic acid, behenic acid, tetracosanoic acid, cerotic acid and montanic acid.

Examples of preferred saturated, aliphatic monocarboxylic acids with 14 to 22 carbon atoms include myristic acid, palmitic acid, stearic acid, hydroxystearic acid, arachic acid and behenic acid.

Saturated, aliphatic monocarboxylic acids such as palmitic acid, stearic acid and hydroxystearic acid are particularly preferred.

The saturated aliphatic C₁₀ to C₃₆ carboxylic acids and the fatty acid esters to be used according to the invention are either known as such from the literature or may be prepared by methods known from the literature. Examples of pentaerythritol fatty acid esters include those of the particularly preferred monocarboxylic acids mentioned above.

Esters of pentaerythritol and of glycerol with stearic acid and palmitic acid are particularly preferred.

Esters of Guerbet alcohols and of glycerol with stearic acid and palmitic acid and optionally hydroxystearic acid are particularly preferred.

Moreover, the molding compound according to the invention may contain organic dyes, inorganic colored pigments, fluorescent dyes and particularly preferably optical brighteners.

All the starting materials and solvents used for the synthesis of the molding compositions according to the invention which may be contaminated from their production and storage with corresponding impurities such as particles, gel solids, ions, solvent residues, monomer or oligomer residues or other compounds should be used in as clean a state as possible.

The mixing of the individual constituents may take place in a known way both successively and simultaneously and both at room temperature and at elevated temperature.

The incorporation of the additives in the molding compositions according to the invention, particularly the antistatics and UV absorbers and other additives mentioned above takes place in a known way by mixing polymer granules with the additives at temperatures from about 200° C. to 350° C. in conventional equipment such as internal mixers, single-screw extruders and twin-screw extruders, for example, by melt compounding or melt extrusion, or by mixing the solutions of the polymers with solutions of the additives in suitable organic solvents such as CH₂Cl₂, halogen alkanes, halogen aromatics, chlorobenzene and xylenes followed by evaporation of the solvents in the known way. The proportion of additives in the molding compound may vary widely and depends on the desired properties of the molding compound. The total proportion of additives in the molding compound is approximately up to 30 wt. %, preferably 0.1 wt. % to 12 wt. %, based on the weight of the molding compound.

The invention provides, therefore, molded parts and extrudates which were manufactured incorporating the molding compositions according to the invention. The molding compositions may be used to produce films, solid plastic sheets and multi-wall sheets (e.g. twin-wall sheets, triple-wall sheets etc.) and corrugated sheets. The multi-layer structures according to the invention also include those which have, on one side or both sides, an additional outer layer with the molding compositions according to the invention with an elevated UV absorber content.

The multi-layer structures according to the invention permit the manufacture of molded parts and extrudates on which no dust deposits are deposited over time, particularly sheets and molded parts produced therefrom, such as glazings for greenhouses, bus shelters, machine covers, advertising boards, signs, protective screens, automobile glazing, windows and roofing.

Subsequent machining operations on extruded parts coated with the molding compound according to the invention such as, thermoforming or surface machining operations are possible and the molded parts produced by these methods also form the subject matter of the patent.

Coextrusion as such is known from the literature (see, for example, EP A 0 110 221 and EP A 0 110 238). In the present case, operations are carried out preferably in accordance with the following description.

Extruders for producing the core layer and outer layer(s) are connected to a coextrusion adapter. The adapter is designed in such a way that the melt forming the outer layer(s) is applied as a thin layer adhering to the melt of the core layer.

The multi-layer melt strand thus produced is then brought to the desired shape (multi-wall or solid sheet) in the die connected downstream. The melt is then cooled under controlled conditions in a known way by calendering (solid sheet) or vacuum calibration and then cut into lengths. Optionally, an annealing furnace to eliminate stresses may also be provided after calibration. Instead of the adapter arranged in front of the die, the die itself may also be designed in such a way that the melts meet there.

### EXAMPLES

The invention will be illustrated further by the examples below but without being limited thereby.

### Example 1

### Additive

396.2 g of perfluorobutane sulfonyl fluoride (1.31 1 mole, Aldrich) and 78.8 g of dimethyidimethoxy silane (0.655 mole, Fluka) were placed in tert-butylmethylether (Aldrich) and 151.1 g of N,N-diisopropylmethylamine (1.311 mole, Fluka) were added slowly at room temperature. The reaction solution was then stirred for 7 h at room temperature until gas evolution subsided and finally the precipitated product was filtered, washed with tert-butylmethylether and dried. Yield: 525 g of white crystals of dimethyidiisopropylammonium perfluorobutyl sulfonate.

### Example 2

### Polymer Containing Additive

MAKROLON® 2808 (linear bisphenol-A polycarbonate from Bayer AG, Leverkusen with a melt flow index (MFR) of 10 g/l 0 min at 300° C. and 1.2 kg load) was compounded as described below with 0.05% of triphenylphosphine, 0.3% of 2-(2′-hydroxy-3′-(2-butyl)-5′-(tert-butyl)-phenyl)-benzotriazole, 0.1% of octadecyl-3-(3′,5-di-tert-butyl-4′-30 hydroxyphenyl)-propionate and 1.5% of dimethyidiisopropyl ammonium perfluorobutyl sulfonate (Example 1).

### Example 3

### Production of Sheets

3 mm solid sheets A to G were produced from the following molding compositions. The base material used was MAKROLON® 3103 (linear bisphenol-A polycarbonate from Bayer AG, Leverkusen with a melt flow index (MFR) of 6.5 g/10 min at 300° C. and 1.2 kg load). This was coextruded with the compounds given in Table 1 based on MAKROLON® 3103 (linear bisphenol-A polycarbonate from Bayer AG, Leverkusen with a melt flow index (MFR) of 6.5 g/10 min at 300° C. and 1.2 kg load).

The compounds were prepared in the following manner: The UV absorber and the antistatic according to Table 1 were incorporated in the polycarbonate at 310° C. and 80 rpm in a twin-screw extruder (ZSK 32, Werner & Pfleiderer) and the extrudate was then granulated.

The thickness of the coextruded layer was about 50 μm in each case.

TABLE 1
Composition of the compounds for the coextruded layers

| Compound | Antistatic | UV-absorber |
|---|---|---|
| A (comparison) | 0% | 0% |
| B (comparison) | 0% | 7% Tinuvin 360***) |
| C (comparison) | 4% Clariant-MB*****) | 0% |
| | NCABRB 12909 | |
| D | 1% Bayowet FT 248*) | 0% |
| E | 0.4% Bayowet FT 248*) | 0.25% Tinuvin 350**) |
| F | 0.4% Bayowet FT 248*) | 7% Tinuvin 360***) |
| G****) | 10% MB from Example 2 | 0% |

*)Available commercially, perfluoro-1-octane sulfonic acid, tetraethylammonium salt from Bayer AG, Leverkusen
**)Available commercially, 2-(2H-benzotriazol-2-yl)-4-(1,1-dimethylethyl)-6-(2-methylpropyl)-phenol from Ciba Spezialitätenchemie, Lampertheim
***)Available commercially, 2,2′-methylenebis[6-(2H-benzotriazol-2-yl)-4-(1,1,3,3-tetramethylbutyl)phenol] from Ciba Spezialitätenchemie, Lampertheim
****)Prepared by mixing granules of MAKROLON ® 3103 and masterbatch
*****)Available commercially from Clariant, Muttenz, Switzerland. Antistatic masterbatch based on non-fluorinated aliphatic sulfonates. The term “MB” means Master Batch.

### Example 4

### Molding Compound According to the Invention, Non Coextruded

An additive-free, unstabilised polycarbonate (MAKROLON® 2808 from Bayer AG, Leverkusen) was compounded at 340° C. on a twin-screw extruder with the amount of perfluorooctane sulfonic acid tetraethylammonium salt given in Table 1 and the other additives mentioned, and then granulated.

Rectangular sheets were then injected from these granules at a melt temperature of 300° C. (155 mm×75 mm×2 mm) and then underwent the dust test.

TABLE 2
Plastic compositions

| Example | Composition |
|---|---|
| 4.1 | 1% Bayowet 248 ® + 0.025% triphenylphosphine + 0.3% 2- |
| | (2′-hydroxy-3′-(2-butyl)-5′-(tert-butyl)-phenyl)-benzotriazole |
| | (Tinuvin ® 350, Ciba Spezialitätenchemie, Basel) |
| 4.2 | 0.6% Bayowet 248 ® + 0.025% triphenylphosphine + 0.3% |
| | 2-(2′-hydroxy-3′-(2-butyl)-5′-(tert-butyl)-phenyl)-benzotriazole |
| 4.3 | 0.4% Bayowet 248 ® + 0.025% triphenylphosphine + 0.3% |
| | 2-(2′-hydroxy-3′-(2-butyl)-5′-(tert-butyl)-phenyl)-benzotriazole |

The machines and apparatus used for the production of multi-layer solid sheets are described below:

The installation comprises:

the main extruder with a screw of length 33D and diameter 60 mm with degassing,

the coex adapter (feedblock system), single-layer, both sides

a coextruder for applying the outer layers with a screw of length 25D and diameter 30 mm

flat sheet die 350 mm wide

3-roll polishing stack, vertical arrangement of rolls

roller conveyor

protective film laminating

haul-off device

length cutting device (saw)

stacking table.

The polycarbonate granules of base material are fed to the filling hopper of the main extruder, the coextrusion material is fed to that of the coextruder. The material in question is melted and conveyed in the relevant cylinder/screw plasticising system. Both material melts meet in the coex adapter and form a composite after leaving the die and cooling between the rollers. The other installations are used for the transport, surface protection and cutting to length of the extruded sheets.

The sheets obtained then underwent a calorimetric evaluation. The following method of measurement was used. Transmission (based on the standards ASTM E 308/ASTM D 1003). Device: Pye-Unicam (measurement geometry: 0°/diffuse, calculated according to light type C). Yellowness index YI in accordance with ASTM E 313.

The dust-repelling effect was tested in the following manner and evaluated with a practical assessment: In order to examine dust accumulation in the laboratory test, the injected sheets were exposed to an atmosphere with fluidised dust. To this end, a 2 I glass beaker with an 80 mm long magnetic stirrer with a triangular cross-section was filled to a height of about 1 cm with dust (charcoal dust 120 g active charcoal, Riedel-de Haen, Seelze, Germany, article no. 18003). The dust was fluidised using a magnetic stirrer. After the stirrer had been stopped, the specimen was exposed to this dust atmosphere for 7 seconds. Depending on the specimen used, dust was deposited on the specimens to a greater or lesser degree. The assessment of the dust accumulations (dust deposits) was carried out visually.

The table below shows that sheets which are coextruded with the molding compositions according to the invention have approximately the same yellowing (Yellowness Index) after manufacture as sheets from known molding compositions not containing additives (1) and are markedly superior in terms of transparency and dust pattern compared with sheets from molding compositions provided with additives other than those according to the invention (2 and 3). Compared with sheets (9-11) which use the molding compositions according to the invention and additives but do not have the multi-layer structure according to the invention, the sheets according to the invention have a markedly lower Yellowness Index.

TABLE 3

| | Coex | Yellowness | | |
|---|---|---|---|---|
| Sheet | layer of: | Index | Transparency | Dust pattern |
| 1 (comparison) | A | <2 | Transparent | Inadequate |
| 2 (comparison) | B | <2 | Transparent | Inadequate |
| 3 (comparison) | C | <2 | Cloudy | Inadequate |
| 4 | D | <2 | Transparent | Very good |
| 5 | E | <2 | Transparent | Very good |
| 6 | F | <2 | Transparent | Very good |
| 7 | G | <2 | Transparent | Very good |
| 8 (comparison) | None | <2 | Transparent | Inadequate |
| 9 (comparison) | 4.1 | 10 | Transparent | Very good |
| 10 (comparison) | 4.2 | 6.9 | Transparent | Very good |
| 11 (comparison) | 4.3 | 5.9 | Transparent | Very good |

As can be seen from the tables above, the desired combination of dust repellency and little impairment of the optical properties may be achieved only with the multi-layer structures according to the invention. Moreover, the multi-layer structures according to the invention exhibit excellent weathering resistance.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A multi-layer structure comprising at least two thermoplastic layers, wherein at least one thermoplastic layer comprises at least one antistatic compound represented by the following formula (I),
R—A—SO₃X (I)
wherein,
R is a perfluorinated linear or branched carbon chain having 1 to 30 carbon atoms;
A is one of a direct bond and a divalent aromatic nucleus;
X is selected from the group consisting of an ammonium ion represented by NR⁵R⁶R⁷R⁸, a phosphonium ion represented by PR⁵R⁶R⁷R⁸, a sulfonium ion represented by SR⁵R⁶R⁷, substituted imidazolinium ion, unsubstituted imidazolinium ion, substituted pyridinium ion, unsubstituted pyridinium ion, substituted tropylium ion, and unsubstituted tropylium ion,
wherein,
R⁵, R⁶, R⁷and R⁸ each independently of one another and independently for each ion, are selected from, aromatic groups; cycloaliphatic groups; and linear or branched C₁-C₃₀ carbon chains; which may each be optionally substituted with at least one member selected from the group consisting of halogen, hydroxy, cycloalkyl and C₁-C₃₀ alkyl.

2. The multi-layer structure of claim 1 wherein said multi-layer structure comprises two exterior layers, at least one of said exterior layers comprising at least one antistatic compound represented by formula (I).

3. The multi-layer structure of claim 1 wherein said multi-layer structure comprises two thermoplastic layers.

4. The multi-layer structure of claim 1 wherein said multi-layer structure comprises three thermoplastic layers, two of said thermoplastic layers defining exterior layers of said multi-layer structure, further wherein at least one of said exterior layers comprises at least one antistatic compound represented by formula (I).

5. The multi-layer structure of claim 1 wherein said multi-layer structure has a total thickness of 21 μm to 10 cm, and each layer independently has a thickness of 1 μm to 10 cm.

6. The multi-layer structure of claim 1 wherein R of formula (I) is a perfluorinated linear or branched carbon chain having 4 to 8 carbon atoms.

7. The multi-layer structure of claim 1 wherein A of formula (I) is selected from o-phenylene, m-phenylene, p-phenylene, fluorinated o-phenylene, fluorinated m-phenylene and fluorinated p-phenylene.

8. The multi-layer structure of claim 1 wherein X of formula (I) is an ammonium ion represented by NR⁵R⁶R⁷R⁸.

9. The multi-layer structure of claim 1 wherein said antistatic compound represented by formula (I) is selected from the group consisting of perfluorooctane sulfonic acid tetraethylammonium salt, perfluorobutane sulfonic acid tetraethylammonium salt, perfluorooctane sulfonic acid tetrapropylammonium salt, perfluorobutane sulfonic acid tetrapropylammonium salt, perfluorooctane sulfonic acid tetrabutylammonium salt, perfluorobutane sulfonic acid tetrabutylammonium salt, perfluorooctane sulfonic acid tetrapentylammonium salt, perfluorobutane sulfonic acid tetrapentylammonium salt, perfluorooctane sulfonic acid tetrahexylammonium salt, perfluorobutane sulfonic acid tetrahexylammonium salt, N-methyl-tripropylammonium perfluorobutyl sulfonate, N-methyl-tripropylammonium perfluorooctane sulfonate, N-ethyl-tripropylammonium perfluorobutyl sulfonate, N-ethyl-tripropylammonium perfluorooctane sulfonate, dimethyidiisopropylammonium perfluorobutyl sulfonate, dimethyidiisopropylammonium perfluorooctane sulfonate, ethyldiisopropylmethylammonium perfluorobutyl sulfonate, ethyldiisopropylmethylammonium perfluorooctane sulfonate, N-methyl-tributylammonium perfluorobutyl sulfonate, N-methyl-tributylammonium perfluorooctane sulfonate, cyclohexyl diethylmethylammonium perfluorobutyl sulfonate, cyclohexyl diethylmethylammonium perfluorooctane sulfonate, cyclohexyltrimethylammonium perfluorobutyl sulfonate, cyclohexyltrimethyl ammonium perfluorooctane sulfonate and mixtures thereof.

10. The multi-layer structure of claim 1 wherein said antistatic compound is selected from perfluoroalkyl sulfonic acid ammonium salts, and each thermoplastic layer that comprises said antistatic compound contains antistatic compound in an amount of 0.001 percent by weight to 2 percent by weight, based on the weight of the thermoplastic layer.

11. The multi-layer structure of claim 1 wherein each thermoplastic layer comprises a thermoplastic polymer selected from at least one of thermoplastic homopolycarbonates, thermoplastic copolycarbonates and thermoplastic polyester carbonates.

12. A method of using the multi-layer structure of claim 1 for the preparation of molded parts and extrudates.

13. A molded article comprising the multi-layer structure of claim 1.

14. The multi-layer structure of claim 1 wherein said multi-layer structure it is prepared by coextrusion.

15. The multi-layer structure of claim 1 wherein said multi-layer structure is selected from films, solid sheets and multi-walled sheets.
